(19) United States
(12) Patent Application Publication
(10) Pub. No.: US 2015/0019799 A1
(43) Pub. Date: Jan. 15, 2015

(54) MULTI-LEVEL MEMORY, MULTI-LEVEL MEMORY WRITING METHOD, AND MULTI-LEVEL MEMORY READING METHOD

(71) Applicant: Sony Corporation, Tokyo (JP)

(72) Inventors: Yutaka Higo, Kanagawa (JP); Masanori Hosomi, Tokyo (JP); Hiroyuki Ohmori, Kanagawa (JP); Kazuhiro Bessho, Kanagawa (JP); Tetsuya Asayama, Tokyo (JP); Kazutaka Yamane, Kanagawa (JP); Hiroyuki Uchida, Kanagawa (JP)

(73) Assignee: Sony Coporation, Tokyo (JP)

(21) Appl. No.: 14/377,752

(22) PCT Filed: Feb. 13, 2013
(86) PCT No.: PCT/JP2013/000761

§ 371 Date: Aug. 8, 2014

(30) Foreign Application Priority Data
Feb. 27, 2012 (JP) 2012-039947

(51) Int. Cl. G06F 3/06; G06F 12/02

(52) U.S. Cl. CPC G06F 3/0661; G06F 12/0246; G06F 3/0614; G06F 3/0688; G06F 2003/0695; G06F 2212/7208
USPC 711/103

(57) ABSTRACT

A memory comprising a memory array unit including a plurality of data units, and a controller. The controller is configured to receive data; convert the data into converted data using a conversion rule for converting a data piece into another data piece, wherein the conversion rule is selected based on the data received and independent of current data written in a data unit; and write the converted data and a conversion rule identifier corresponding to the conversion rule into the data unit.

### TECHNICAL FIELD

The present disclosure relates to a multi-level memory that stores two or more bits of information in one memory cell, a multi-level memory writing method, and a multi-level memory reading method.

### CITATION LIST

### Patent Literature

### [PTL 1]

### Japanese Patent No. 4134637

### [PTL 2]

### Specification of US Patent Application Publication No. 2011/0213995

### BACKGROUND ART

In the past, as small-sized electronic devices which are used in information processing apparatuses, particularly in mobile terminals, and the like have been rapidly distributed, demand for higher performance including higher integration, higher speed, lower energy consumption, and the like has been made on memory elements, logic elements, and the like included in such electronic devices.

In such small-sized devices, a non-volatile memory is regarded as an indispensible component for achieving higher functions of electronic devices. As a non-volatile memory, a semiconductor flash memory, a FeRAM (Ferroelectric Random Access Memory), an MRAM (Magnetoresistive Random Access Memory), and the like have been put into practical use, and research and development have been actively conducted in order to attain even higher performance.

In addition, in a semiconductor flash memory, and the like, there is a case that a memory cell is used to store two or more bits of information as a data value in one memory cell, in order to increase the storage capacity. Such a memory cell is called an MLC (Multi Level Cell). On the other hand, a memory cell storing one bit of information in one memory cell is called an SLC (Single Level Cell). A memory using an MLC is called a multi-level memory.

Writing information on a non-volatile memory consumes energy. For this reason, various kinds of writing methods have been proposed in order to reduce consumption energy during writing.

For example, in PTL 1, a method for writing information on an MRAM is disclosed. In this writing method, input data is compared to data that has already been written in a region in which the input data is supposed to be written, and then encoding is performed so that the number of bits to be rewritten is decreased to half or lower thereof. In this manner, the number of bits to be rewritten can be decreased during a writing operation, and therefore consumption energy can be reduced.

In addition, in the writing method disclosed in PTL 2, input data is compared to data that has already been written in a region in which the input data is supposed to be written, and if the number of bits to be rewritten is the half or more, the data is replaced with “0” and “1” of the input data. Thus, only bits that need to be rewritten are rewritten. Further, a bit for storing information of whether “0” and “1” have replaced the input data or not is added, and the bit is also simultaneously written.

### SUMMARY

### Technical Problem

A multi-level memory using an MLC stores two or more bits of information in one memory cell. Let us assume a case in which two bits of information are stored. In this case, data to be written includes “00,” “01,” “10,” and “11.” Energy to be consumed when the data is written (hereinafter referred to as writing energy) is different depending on data to be written. Writing energy of when “00” is written is set to be E(00), or the like. When it is assumed that writing energy increases in the order of the above-described data, E(00)<E(01)<E(10)<E(11) is satisfied. For this reason, writing energy is consumed more, for example, when a large quantity of “11” is written than when a large quantity of “00” is written.

Note that this quantitative relationship of writing energy is an assumption for explanation, and there are also cases of other quantitative relationships.

In addition, a non-volatile memory has a problem in that the memory has an upper limit in the number of times capable of rewriting. Generally, the upper limit in the number of times capable of rewriting is related to writing energy. This is because stress is imposed on a memory cell according to the amount of writing energy. For example, in the case of a current writing type MRAM, when writing is performed, electric field stress is imposed on a tunnel barrier film constituting a memory cell. The electric field stress accumulates as writing is repeated, and finally, the tunnel barrier film causes electrostatic breakdown. Then, it is difficult to write new information on the memory cell any further. In other words, there is an upper limit in the number of times capable of rewriting. Since the electric field stress increases as writing energy becomes greater, the number of times capable of rewriting decreases as writing energy becomes greater. In other words, when the case in which “00” is continuously written and the case in which “11” is continuously written in the same memory cell are compared, the number of times capable of rewriting further decreases in the case in which “11” is continuously written.

As above, in a multi-level memory, there is data that is disadvantageous in consumption energy and the number of times capable of rewriting during writing, and it is desirable that such data be written as little as possible.

It is desirable to decrease the number of times of writing data using a large amount of writing energy that is disadvantageous in the number of times capable of rewriting as consumption energy becomes greater.

### Solution to Problem

A memory according to the disclosure comprises a memory array unit including a plurality of data units, and a controller. The controller is configured to receive data; convert the data into converted data using a conversion rule for converting a data piece into another data piece, wherein the conversion rule is selected based on the data received and independent of current data written in a data unit; and write the converted data and a conversion rule identifier corresponding to the conversion rule into the data unit.

A method of writing data into a memory including a memory array unit having a plurality of data units according to the disclosure includes receiving data; converting the data into converted data using a conversion rule for converting a data piece into another data piece, wherein the conversion rule is selected based on the data received and independent of current data written in a data unit; and writing the converted data and a conversion rule identifier corresponding to the conversion rule into the data unit. In addition, a method of reading data from a memory including a memory array unit having a plurality of data units according to the disclosure includes reading converted data and a conversion rule identifier from a data unit; determining a conversion rule corresponding to the conversion rule identifier; reverse converting the converted data into reversely converted data using the conversion rule; and transmitting the reversely converted data.

In this way, it is possible to decrease the number of writing times of data that is disadvantageous in consumption energy and the number of times capable of rewriting.

### Advantageous Effects of Invention

According to this disclosure, since it is possible to decrease the number of writing times of data that is disadvantageous in consumption energy and the number of times capable of rewriting, there are effects of reducing consumption energy during writing and increasing the number of times capable of rewriting.

### BRIEF DESCRIPTION OF DRAWINGS

FIG. 1 is a block diagram of a multi-level memory according to an embodiment of the disclosure.

FIG. 2 is an illustrative diagram of a data unit according to an embodiment of the disclosure.

FIG. 3 is a conceptual diagram showing a storage state of a memory cell.

FIG. 4 is a diagram showing an example of conversion rules.

FIG. 5 is a flowchart of a writing process according to an embodiment of the disclosure.

FIG. 6 is a flowchart of a reading process according to an embodiment of the disclosure.

FIG. 7 is a diagram showing conversion rules according to a first embodiment.

FIG. 8 is a flowchart for describing an operation of a conversion rule determination unit according to the first embodiment.

FIG. 9 is a diagram showing conversion rules according to a second embodiment.

FIG. 10 is a flowchart for describing an operation of a conversion rule determination unit according to the second embodiment.

FIG. 11 is a diagram showing conversion rules according to a third embodiment.

FIG. 12 is a flowchart for describing an operation of a conversion rule determination unit according to the third embodiment.

### DESCRIPTION OF EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, embodiments of the disclosure will be described in the following order.

### <1. Overview of Multi-Level Memory of Embodiment>

### <2. First Embodiment>

### <3. Second Embodiment>

### <4. Third Embodiment>

### 1. Overview of Multi-Level Memory of Embodiment

FIG. 1 shows a configuration of a multi-level memory according to an embodiment. The multi-level memory 10 of FIG. 1 includes a memory control unit 10, a memory array unit 20, and an internal bus 3. In addition, the multi-level memory 1 performs communication with a host not shown in the drawing via a system bus 2.

The memory control unit 1 processes writing and reading requests transmitted from the host. When there is a writing request, an address and writing data are received via the system bus 2, and the information is written in a corresponding location in the memory array unit 20 via the internal bus 3. When there is a reading request, an address is received through the system bus 2, data retained in a corresponding location of the memory array unit 20 is read via the internal bus 3, and the data is transmitted to the host via the system bus 2.

The memory control unit 10 includes an input and output buffer, a writing/reading circuit, and the like not shown in the drawing but necessary for executing the processes. The memory control unit 10 further includes a data conversion section 11, a conversion rule holding section 12, a conversion rule determination section 13, and a data reverse conversion section 14. The functions of the components will be described in detail later.

The memory array unit 20 includes a plurality of memory cells for storing data. Each memory cell holds two or more bits of information. The memory cells are managed as data units 21 in each predetermined number of units. In FIG. 1, there are B1 to Bk data units 21, and the memory array unit 20 includes k data units.

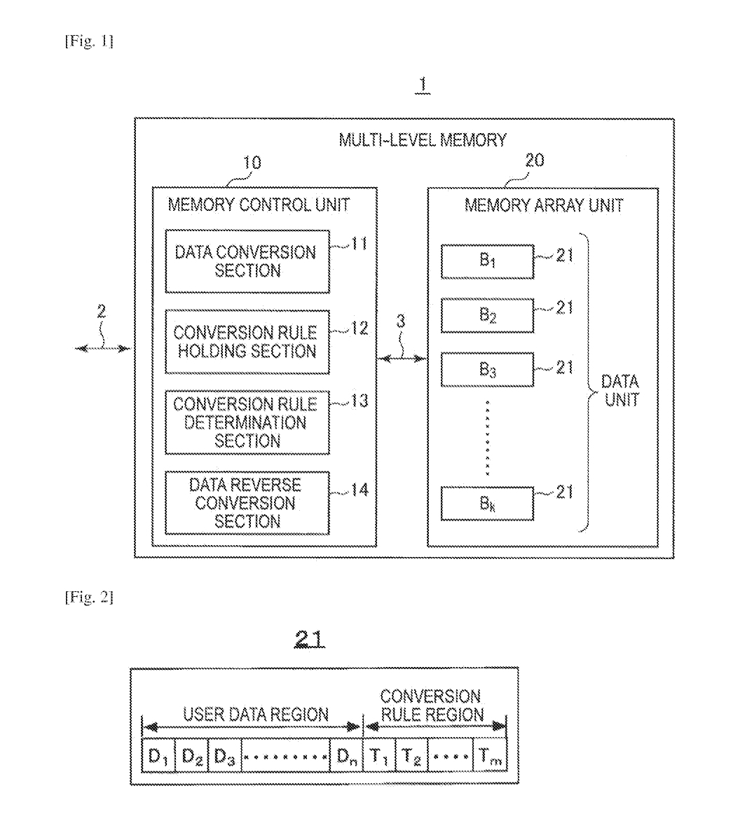

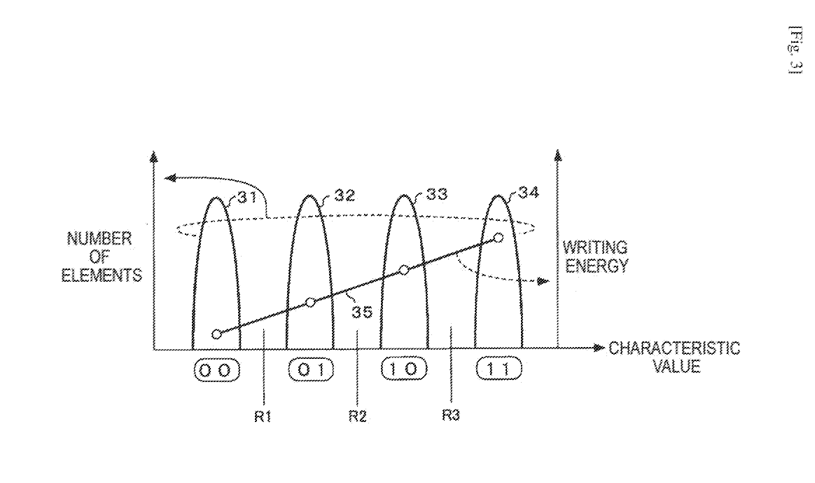

FIG. 2 shows a configuration of the data units 21.

Each data unit 21 is divided into a user data region and a conversion rule region. In FIG. 2, the user data region includes memory cells D1 to Dn, and the conversion rule region includes memory cells T1 to Tm. As a result, each data unit 21 has (n+m) memory cells.

FIG. 3 shows a conceptual diagram of a storage state of a memory cell. The horizontal axis represents arbitrary characteristic values. In the case of a flash memory, for example, the horizontal axis represents threshold voltage of a memory cell. In the case of a resistance change type memory, the horizontal axis represents resistance values of a memory cell. Curves 31 to 34 are distribution curves indicating how many memory cells (the number of elements) corresponding to the characteristic values there are in the multi-level memory 1, with regard to the characteristic values on the horizontal axis. In the example of FIG. 3, there are four distributions for the characteristic values. As two-bit data values, “00,” “01,” “10,” and “11” can be assigned to each of the distributions from the lower side of the characteristic values. Since one memory cell can have any one of the four states (data portions) in this manner, memory cells can store two bits of information as a data value.

In order to read which data has been stored, reference values R1, R2, and R3 set between the distributions are compared to the characteristic values of the memory cells. For example, when a characteristic value is greater than the reference value R1 and smaller than R2, it can be determined that the memory cell thereof stores “01.”

Next, when data is to be written on the memory cells, a writing operation is performed according to the operation principle of the memory cells. For example, in the cases of a flash memory and a resistance change type memory, a fixed writing voltage is applied to a writing terminal of the memory cells for a fixed period of writing time. Here, the writing voltage, the writing time, or both values are changed according to the writing data. With this operation, different data pieces can be written on the memory cells.

Here, writing energy of which the amount is decided based on the writing voltage and the writing time is consumed. Since the writing voltage, the writing time, or both values are different depending on the data pieces to be written, the amount of writing energy also has different values depending on the data pieces to be written.

Straight line 35 of FIG. 3 schematically shows this relationship. The writing energy when “00” is written is assumed to be E(00), and the like. In the example of FIG. 3, E(00)<E(01)<E(10)<E(11) is set. For this reason, more of the writing energy is consumed, for example, when a large quantity of “11” is written than when a large quantity of “00” is written. In other words, writing “11” consumes the maximum amount of energy. In addition, when writing is repeated with the writing energy, the number of times capable of rewriting decreases.

For the above reason, when the number of times of writing “11” can be decreased to be as low as possible, low energy consumption and an increase in the number of times of rewriting can be attained.

Description below is on the premise of the relationship E(00)<E(01)<E(10)<E(11), but it is not limited to the fact that E(11) consumes the maximum energy, and the same principle is true when other relationships are appropriately applied.

In addition, the number of bits that the memory cell can store is not limited to two, and a higher number of bits is also possible.

As described hitherto, a multi-level memory has data of which the number of times of writing is desired to be decreased. However, when writing data is completely at random, all data pieces are naturally written at the same ratio. Therefore, according to this disclosure, a decrease in the number of times of writing of data of which the number of times of writing is desired to be decreased is realized by using the data conversion section 11, the conversion rule holding section 12, the conversion rule determination section 13, and the data reverse conversion section 14 shown in FIG. 1.

Hereinbelow, a method thereof will be described.

In order to decrease the number of times of writing a specific data piece (for example, “11”) of which the number of times of writing is desired to be decreased, writing may be performed by converting the data piece into another data piece (for example, “00”). With this operation, the data piece (“11”) of which the number of times of writing is desired to be decreased may not be written.

If this conversion is performed, however, when the original writing data includes “00,” data collision occurs. Thus, “00” is further converted to another data piece for writing. In this manner, a conversion rule is defined which is designed for writing all data pieces without collision. When memory cells can respectively store two bits of data, the total number of conversion rules that can be considered is 4*3*2*1=24.

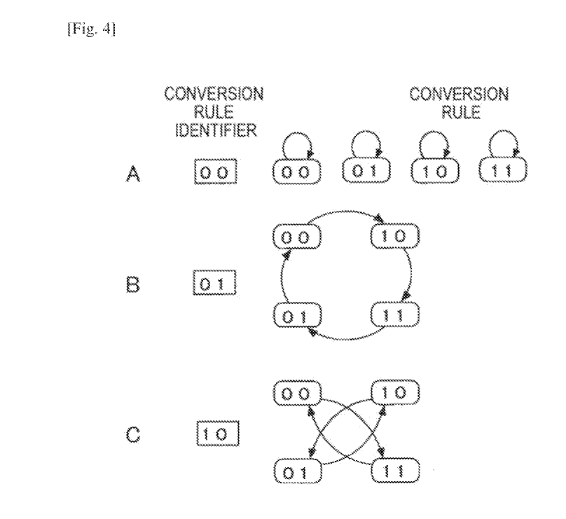

FIG. 4 shows an example of such conversion rules. Arrows indicate the conversion of data, and the data in the root of each arrow is converted into data at the tip of each arrow. In a conversion rule A, all arrows points to the data pieces of their own. In other words, no conversion is performed. In a conversion rule B, “00,” “01,” “10,” and “11” are converted in a circulating manner. In a conversion rule C, conversion is performed between “00” and “11” and between “10” and “01.”

When conversions are performed, it is necessary to store which rules are used for the conversions on the memory cells. Otherwise, when data after conversion is to be read, the original data is unable to be restored. In order to store the conversion rules, unique conversion rule identifiers are assigned to each of the conversion rules. In this example, the total number of conversion rules is 24. Thus, the conversion rule identifiers are from “00.00.00” to “01.01.11” and each conversion rule takes one unique conversion rule identifier among them. Since a memory cell is a 2-bit cell, three memory cells are necessary for storing the conversion rule identifiers.

In order to use the memory cells for storing the conversion rules, regions storing the original writing data are reduced. In order to lower the effect thereof, a plurality of writing data pieces may be converted using the same conversion rule. With this operation, the relative ratio of the memory cells configured to store the conversion rules can be lowered. Hereinbelow, a gathering of the plurality of writing data pieces converted using the same conversion rule will be referred to as user data.

It has been described above that the number of conversion rules is 24, but it is not necessary to use all of the conversion rules. There may be a case in which only three conversion rules A, B, and C shown in FIG. 4 are used.

In this case, a conversion rule identifier “00,” a conversion rule identifier “01,” and a conversion rule identifier “10” can be respectively assigned to the conversion rule A, the conversion rule B, and the conversion rule C. With this operation, the conversion rule identifiers can be stored in one memory cell.

Herein, conversion examples of user data when the three conversion rules A, B, and C shown in FIG. 4 are used will be described. Returning to FIG. 1, the memory control unit 10 includes the data conversion section 11, the conversion rule holding section 12, the conversion rule determination section 13, and the data reverse conversion section 14. The functions thereof will be described through the conversion examples of user data. Note that, for convenience of description, the width of the user data is assumed to be four memory cells.

First, as a preparation step, the conversion rules A, B, and C, and the conversion rule identifiers thereof are stored in the conversion rule holding section 12.

As a first example, a case in which there is a request to write user data “00.00.01.11” is considered. When the memory control unit 10 receives the user data via the system bus 2, the data is transmitted to the conversion rule determination section 13. The conversion rule determination section 13 checks the received user data, and selects a conversion rule by which “11” may not be written from a plurality of conversion rules stored in the conversion rule holding section 12.

In other words, the conversion rule determination section 13 can change a conversion rule to be selected according to writing data.

In this example, the conversion rule B can be used. The data conversion section 11 converts “11” into “01,” “01” into “00,” and “00” into “10” using the selected conversion rule B. The conversion rule B also includes a rule of converting “10” into “11,” but since this user data does not include “10,” the rule is not applied. Then the memory control unit 10 matches the converted user data with “01” that is a conversion rule identifier of the conversion rule B, and writes the user data in a corresponding data unit 21 of the memory array unit 20. The user data corresponds to the conversion rule identifiers one to one.

At this moment, data to be written in the data unit 21 is “10.10.00.01, 01.” In this case, the front portion of “,” corresponds to user data, and the rear portion thereof corresponds to a conversion rule identifier. Then, as shown in FIG. 3, the user data is written in the user data region in the data unit 21 and the conversion rule identifier is written in the conversion rule region in the data unit 21. In the entire data units, writing is performed for five memory cells, but none of the memory cells is written with “11.” With this operation, user data can be stored in the memory cells without writing “11” that is not desired to be written.

When there is a reading request, the process may be performed in a reverse manner. The memory control unit 10 reads the user data (“10.10.00.01”) and the conversion rule identifier (“01”) from the corresponding data unit 21. Since the user data and the conversion rule identifier correspond to each other one to one, the conversion rule determination section 13 determines that the conversion rule B has been used from the fact that the read conversion rule identifier is “01,” referring to the conversion rule holding section 12. The data reverse conversion section 14 reversely converts “01” into “11,” “00” into “01,” and “10” into “00” by reversely using the conversion rule B. As a result, the user data after the reverse conversion is “00.00.01.11.” The memory control unit 10 transmits the user data after the reverse conversion to the request source via the system bus 2.

In the first example, since “10” is not included in the user data, the conversion rule B can be used. As another case, when “11” is included but “00” is not included in user data, the conversion rule C can be used.

Next, as a second example, a case in which there is a request to write user data “00.01.10.11” is considered. In this case, since all data pieces (“00,” “01,” “10,” and “11”) are included in the user data, writing “11” occurs no matter what conversion is performed. For this reason, the conversion rule determination section 13 selects the conversion rule A that is a conversion rule of “conversion will not be performed.” Other operations are the same as those in the first example. Data to be written in the data unit 21 is “00.01.10.11,00.”

In this manner, although writing of “11” occurs when all data pieces are included in user data, such cases are rare in reality. In other words, when the width of user data is four memory cells and each memory cell is a 2-bit cell, the total number of data patterns is 4⁴=256, but when all data pieces are included in the user data, the number is 24. This is the reason that the number of times of writing of data which is not desired to be written can be decreased according to this disclosure.

The above-described writing and reading processes will be described using a flowchart.

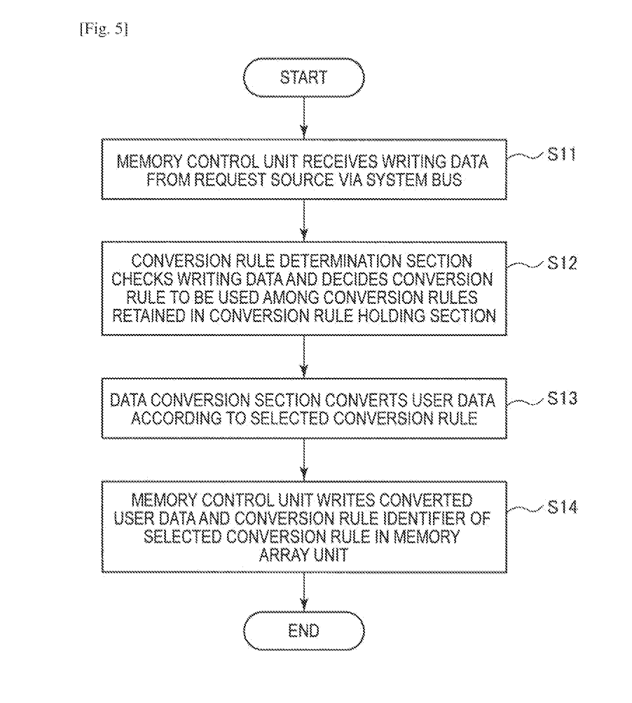

FIG. 5 is a flowchart of a writing process according to an embodiment of the disclosure.

In Step S11, the memory control unit 10 receives writing data from a request source via the system bus 2. In Step S12, the conversion rule determination section 13 checks the writing data, and decides a conversion rule to be used among conversion rules retained in the conversion rule holding section 12. In Step S13, the data conversion section 11 converts user data according to the selected conversion rule. In Step S14, the memory control unit 10 writes the converted user data and the conversion rule identifier of the selected conversion rule in the memory array unit 20.

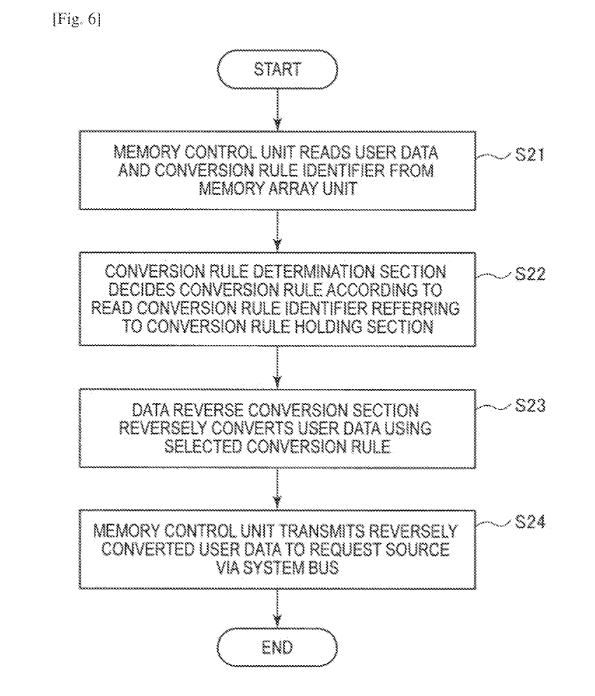

FIG. 6 is a flowchart of a reading process according to an embodiment of the disclosure.

In Step S21, the memory control unit 10 reads user data and a conversion rule identifier from the memory array unit 20. In Step S22, the conversion rule determination section 13 decides the conversion rule corresponding to the read conversion rule identifier referring to the conversion rule holding section 12. In Step S23, the data reverse conversion section 14 reversely converts the user data using the selected conversion rule. In Step S24, the memory control unit 10 transmits the reversely converted user data to the request source via the system bus.

### 2. First Embodiment

Next, a first embodiment will be described.

Herein, a specific conversion rule according to the first embodiment will be present, and an effect obtained by applying the conversion rule will also be described in detail. Note that it is assumed that a memory cell stores two bits and the width of user data is four memory cells in the same manner as in the previous example. In this case, in FIG. 2, the user data region of each data unit 21 includes four memory cells D1, D2, D3, and D4.

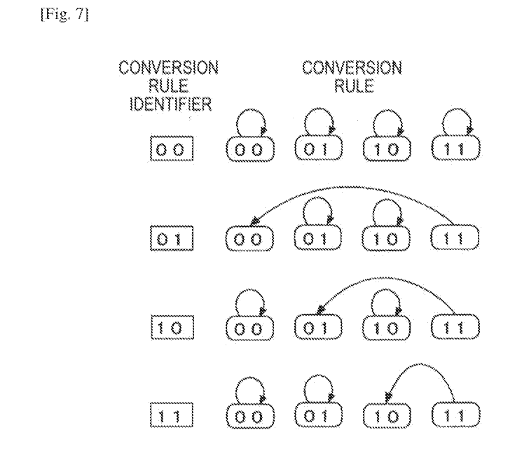

FIG. 7 is a diagram showing conversion rules according to the first embodiment. In the first embodiment, four conversion rules are used. The four conversion rules according to the first embodiment are collectively referred to as a conversion rule set 1. Since the number of conversion rules is four, the number of memory cells necessary for storing a conversion rule identifier is 1. In this case, the conversion rule region of the data unit 21 in FIG. 2 includes one memory cell T1.

In the conversion rule indicated by the conversion rule identifier “00,” data is not converted. In the conversion rule indicated by the conversion rule identifier “01,” “11” is converted into “00.” “01” and “10” are not converted. “00” is originally set to be converted into “11,” but since there is the premise that the conversion rule is not applied to user data including “00” in the first place, the rule is not described in FIG. 7. In the conversion rule indicated by the conversion rule identifier “10” and the conversion rule indicated by the conversion rule identifier “11,” “11” is converted into “01” and “10” respectively in the same manner, and other data pieces are not converted.

FIG. 8 is a flowchart for describing an operation of the conversion rule determination section 13 according to the first embodiment.

In Step S31, it is determined whether the user data includes “11” or not. When “11” is not included, the conversion rule indicated by the conversion rule identifier “00” is selected (Step S32).

In Step S33, it is determined whether the user data includes “00” or not. When “00” is not included, the conversion rule indicated by the conversion rule identifier “01” is selected (Step S34).

In Step S35, it is determined whether the user data includes “01” or not. When “01” is not included, the conversion rule indicated by the conversion rule identifier “10” is selected (Step S36).

In Step S37, it is determined whether the user data includes “10” or not. When “10” is not included, the conversion rule indicated by the conversion rule identifier “11” is selected (Step S38).

Finally, there is a remaining case in which the user data includes all data pieces, and in this case, the conversion rule indicated by the conversion rule identifier “00” is selected (Step S39).

[symbol]

[symbol]

indicates data missing or illegible when filed

In order to describe an effect when the conversion rule set 1 is used, first, a writing frequency when conversion is not performed (comparative example) was calculated. Table 1 shows a writing frequency of data according to the comparative example. As previously described, the number of patterns of user data including four 2-bit memory cells is 256. Writing was performed in each of the patterns. Then, the number of times of writing each data piece (“00,” “01,” “10,” “11”) in each memory cell was calculated. Of course, when conversion is not performed, the number of times of writing each of the data pieces is uniformly 64, and the ratio is 25% on a percentage basis.

[symbol]

[symbol]

indicates data missing or illegible when filed

Next, a writing frequency when the conversion rule set 1 is used was calculated. The result is shown in Table 2.

Since conversion had been performed, calculation was performed for each of the user data D1, D2, D3, and D4, and the conversion rule identifier T1. As a result, it is ascertained that the number of times of writing the user data D1, D2, D3, and D4, and the conversion rule identifier T1 satisfies “00”>“01”>“10”>“11,” and the number of times of writing “11” that is data particularly not desired to be written drastically decreases. Particularly focusing only on the user data region, the ratio of writing “11” decreases to as little as 2%.

### 3. Second Embodiment

Next, a second embodiment will be described.

In the first embodiment, there is a case in which a conversion rule identifier is “11.” Originally, since the goal is to decrease the number of times of writing “11,” even writing “11” in the conversion rule region of the data unit 21 is an operation at odds with the original goal.

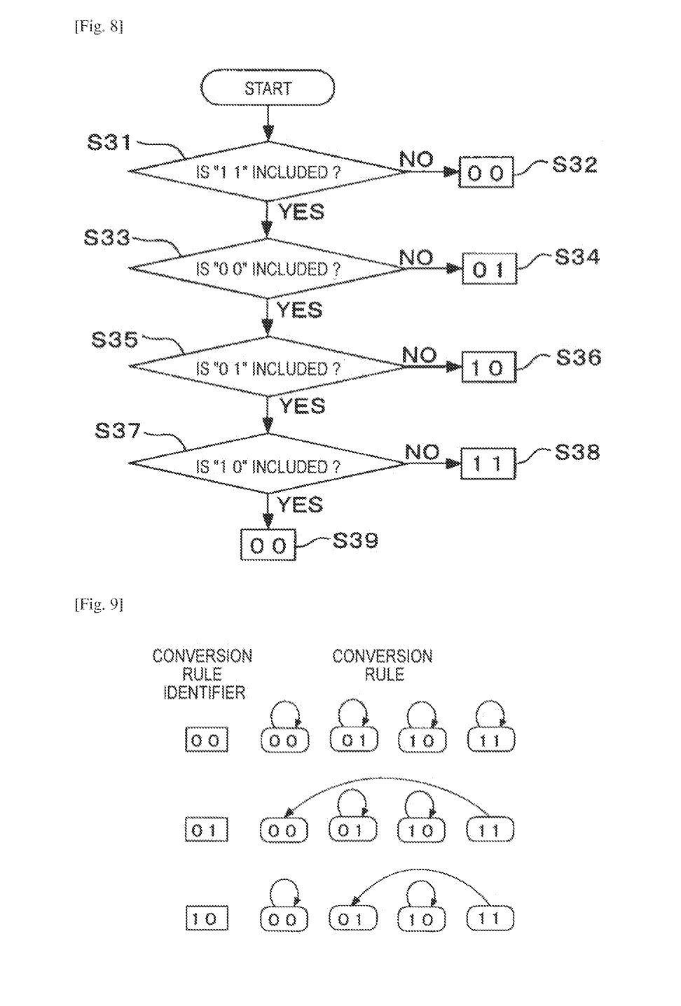

For the purpose of such an operation, the second embodiment changes the conversion rules as shown in FIG. 9. That is, the conversion rule in which the conversion rule identifier is “11” that is originally included in the conversion rule set 1 is omitted. Other conversion rules are the same as the conversion rule set 1.

The three conversion rules according to the second embodiment are collectively referred to as a conversion rule set 2. Since the number of conversion rules is 3, the number of memory cells necessary for storing the conversion rule identifiers is 1. In this case, as in the first embodiment, the user data region of the data unit 21 includes four memory cells D1, D2, D3, and D4, and the conversion rule region of the data unit 21 includes one memory cell T1.

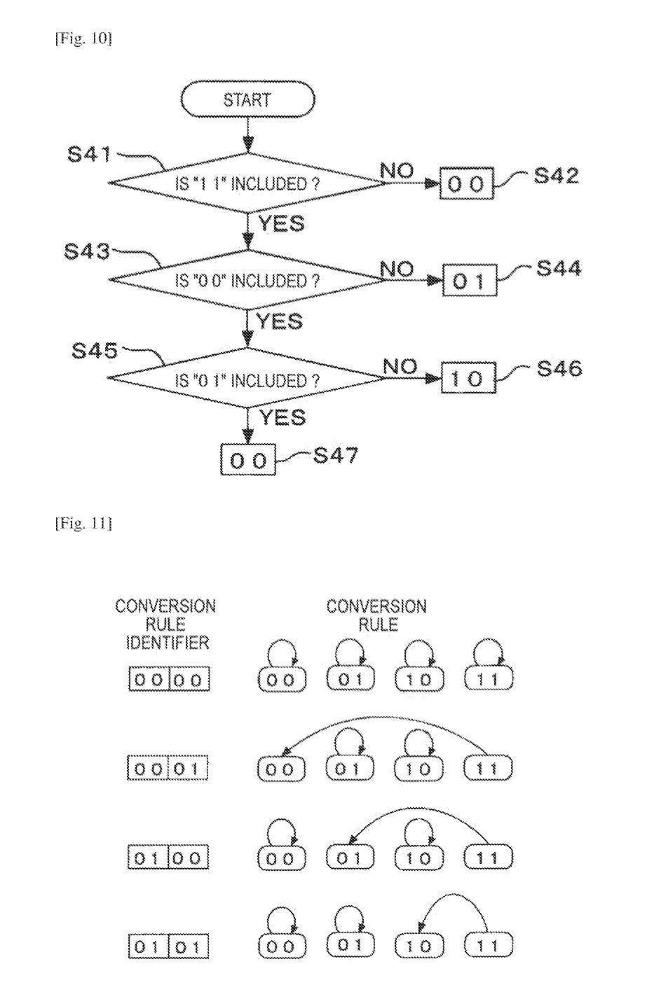

FIG. 10 is a flowchart for describing an operation of the conversion rule determination section 13 according to the second embodiment.

In Step S41, it is determined whether the user data includes “11” or not. When “11” is not included, the conversion rule indicated by the conversion rule identifier “00” is selected (Step S42).

In Step S43, it is determined whether the user data includes “00” or not. When “00” is not included, the conversion rule indicated by the conversion rule identifier “01” is selected (Step S44).

In Step S45, it is determined whether the user data includes “01” or not. When “01” is not included, the conversion rule indicated by the conversion rule identifier “10” is selected (Step S46).

Finally, there is a remaining case in which the user data includes all of “11,” “00,” and “01,” and in this case, the conversion rule indicated by the conversion rule identifier “00” is selected (Step S47).

[symbol]

[symbol]

indicates data missing or illegible when filed

In order to describe an effect of when the conversion rule set 2 is used, the writing frequency was calculated. The result is shown in Table 3. Calculation was performed for the user data D1, D2, D3, and D4, and the conversion rule identifier T1. As a result, it is ascertained that the number of times of writing the user data D1, D2, D3, and D4, and the conversion rule identifier T1 satisfies “00”>“01”>“10”>“11,” and the number of times of writing “11” that is data that is particularly not desired to be written drastically decreases. In addition, “11” is never written in the conversion rule region. However, as a side effect, the number of times of writing “11” in the user data region is 18, which is three times greater than 6 of when the conversion rule set 1 is used. Nonetheless, the ratio is drastically decreased in comparison to 25% of the number of times of writing in the comparative example.

### 4. Third Embodiment

Next, a third embodiment will be described.

In the first embodiment, there is a case in which the conversion rule identifier is “11.” On the other hand, in the second embodiment, while there is no case in which the conversion rule identifier is “11,” the number of times of writing “11” in the user data region is greater than that in the first embodiment.

Thus, in the third embodiment, conversion rules are shown in which there is no case in which the conversion rule identifier is “11,” and at the same time, the number of times of writing “11” in the user data region is equal to that of the first embodiment.

FIG. 11 is a diagram showing conversion rules according to the third embodiment. The conversion rules themselves are the same as those in the first embodiment.

The four conversion rules according to the third embodiment are collectively referred to as a conversion rule set 3. Since the number of conversion rules is four, the number of memory cells necessary for storing conversion rule identifiers is 1, but two memory cells are used particularly in the third embodiment. In this case, the user data region of the data unit 21 includes four memory cells of D1, D2, D3, and D4, and the conversion rule region of the data unit 21 includes two memory cells of T1 and T2.

In the first embodiment, the conversion rule identifiers are “00,” “01,” “10,” and “11.” In this case, since the number of memory cells is one (two bits), if four conversion rule identifiers are to be expressed, the conversion rule identifier of “11” should be used. In order to avoid this situation, two memory cells T1 and T2 are prepared.

In the third embodiment, the conversion rule identifiers are replaced with “00.00,” “00.01,” “01.00,” and “01.01” in that order. Herein, the conversion rule identifier before the period “.” corresponds to the memory cell T1 in the conversion rule region, and the conversion rule identifier after that corresponds to the memory cell T2 in the conversion rule region. In other words, data pieces that are likely to be written in T1 and T2 are only “00” and “01.”

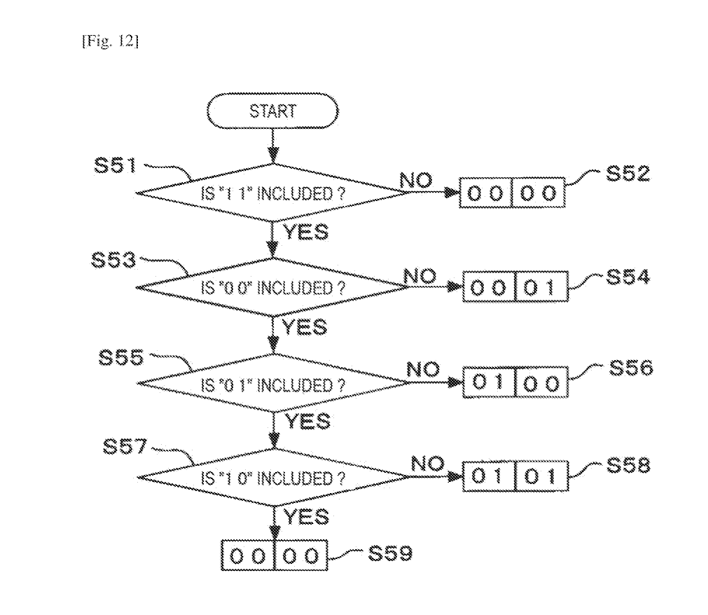

FIG. 12 is a flowchart for describing an operation of the conversion rule determination section 13 according to the third embodiment. The flowchart is the same as that showing the operation of the conversion rule determination section 13 according to the first embodiment shown in FIG. 8 except that a selected conversion rule identifier is any one of “00.00,” “00.01,” “01.00,” and “01.01.”

In Step S51, it is determined whether the user data includes “11” or not. When “11” is not included, the conversion rule indicated by the conversion rule identifier “00.00” is selected (Step S52).

In Step S53, it is determined whether the user data includes “00” or not. When “00” is not included, the conversion rule indicated by the conversion rule identifier “00.01” is selected (Step S54).

In Step S55, it is determined whether the user data includes “01” or not. When “01” is not included, the conversion rule indicated by the conversion rule identifier “01.00” is selected (Step S56).

In Step S57, it is determined whether the user data includes “10” or not. When “10” is not included, the conversion rule indicated by the conversion rule identifier “01.01” is selected (Step S58).

Finally, there is a remaining case in which the user data includes all data pieces, and in this case, the conversion rule indicated by the conversion rule identifier “00.00” is selected (Step S59).

[symbol]

[symbol]

indicates data missing or illegible when filed

In order to describe an effect of when the conversion rule set 3 is used, the writing frequency was calculated. The result is shown in Table 4. Since conversion had been performed, calculation was performed for the user data D1, D2, D3, and D4, and the conversion rule identifiers T1 and T2. Since the conversion rules themselves are the same as those in the first embodiment, the number of times of writing the user data D1, D2, D3, and D4 is the same as that of the first embodiment. In addition, unlike the first embodiment, only “00” or “01” are written in the conversion rule identifiers T1 and T2.

In this way, in the third embodiment, the ratio of writing “11” in the user data region is 2%, and “11” is never written in the conversion rule region.

According to the embodiments of the disclosure as above, it is ascertained that the number of times of writing data that is not desired to be written (“11” in the above examples) can be drastically decreased by selecting an appropriate data conversion rule.

The conversion rules exemplified in the embodiments of the disclosure are merely examples, and other conversion rules may be used.

In addition, it is desirable that a copy of the conversion rules stored in the conversion rule holding section 12 also be stored in the memory array unit 20 so that the conversion rules are not lost even when power supply to the multi-level memory is disconnected.

Further, the arrangement of the user data region and the conversion rule region in the data unit 21 is not fixed, but can be changed. In other words, a so-called smoothing operation in which a memory cell allocated to a user data region at one point is allocated to a conversion rule region at another point may be performed.

Additionally, the present technology may also be configured as below.

(1)
A multi-level memory including:
a memory array unit that includes a plurality of memory cells, each of which stores two or more bits of data values; and
a memory control unit that converts a specific data value among data values to be written in one memory cell to a data value other than the specific data value based on a conversion rule according to data to be written in the memory array unit, and performs a process of writing the converted writing data and a conversion rule identifier indicating a conversion rule of the conversion in the memory array unit.
(2)
The multi-level memory according to (1), wherein, in the memory array unit, a memory cell region storing the converted writing data and a memory cell region storing the conversion rule identifier correspond to each other one to one.
(3)
The multi-level memory according to (1) or (2), wherein the memory control unit includes a conversion rule holding part that holds a plurality of conversion rules for converting the writing data, a conversion rule determination part that selects one conversion rule from the conversion rule holding part according to the writing data, and a data conversion part that converts the writing data in compliance with the conversion rule selected by the conversion rule determination part.
(4)
The multi-level memory according to (3), wherein, among the plurality of conversion rules stored in the conversion rule holding part, one conversion rule is a conversion rule in which conversion of the writing data is not performed.
(5)
The multi-level memory according to any one of (1) to (4), wherein, among all data values that are likely to be written in one memory cell, the specific data value is a data value when the maximum amount of energy is consumed during writing.
(6)
The multi-level memory according to any one of (1) to (5), wherein the memory control unit includes a data reverse conversion part that restores the data value of data read from the memory array unit to the original data value before the conversion based on the conversion rule identifier read from the memory array unit, and wherein data reversely converted in the data reverse conversion part is output as reading data.
(7)
The multi-level memory according to any one of (1) to (6), wherein a value used as the conversion rule identifier is not included in the specific data value.
(8)
A memory comprising: a memory array unit including a plurality of data units; and a controller configured to receive data; convert the data into converted data using a conversion rule for converting a data piece into another data piece, wherein the conversion rule is selected based on the data received and independent of current data written in a data unit; and write the converted data and a conversion rule identifier corresponding to the conversion rule into the data unit.
(9)
A memory of (7), wherein the plurality of data units have multi-level cells used to store two or more bits of information.
(10)
A memory of any one of (7) and (9), further comprising: a storage unit configured to store at least one conversion rule and at least one corresponding conversion rule identifier.
(11)
A memory of (10), wherein the controller is further configured to: select the conversion rule from among the at least one conversion rule stored in the storage unit.
(12)
A memory of any one of (10) and (11), wherein the storage unit is configured to store a conversion rule that keeps the converted data the same as the received data, and to store a corresponding conversion rule identifier.
(13)
A memory of any one of (8), (9), (10), (11), and (12), wherein a conversion rule requiring the least write energy to write the converted data is selected.
(14)
A memory of any one of (8), (9), (10), (11), (12), and (13), wherein a conversion rule is selected by which a data piece consuming a maximum write energy among all possible data pieces is written into the data unit the least.
(15)
A memory of any one of (8), (9), (10), (11), (12), (13), and (14), wherein a conversion rule is selected that satisfies a data piece consuming a least write energy is written a larger number of times than a data piece consuming a second least write energy which is written a larger number of times than a data piece consuming a second most write energy which is written a larger number of times than a data piece consuming a maximum write energy.
(16)
A memory of any one of (8), (9), (10), (11), (12), (13), (14), and (15), wherein each data unit has a data region and a conversion rule region, and the controller is further configured to: write the converted data into the data region of the data unit, and write the conversion rule identifier into the conversion rule region of the data unit.
(17)
A memory of any one of (8), (9), (10), (11), (12), (13), (14), (15), and (16), wherein the conversion rule is written into the data unit without using a data piece consuming a maximum write energy.
(18)
A memory of any one of (8), (9), (10), (11), (12), (13), (14), (16), and (17), wherein the conversion rule is written into the data unit using only a data piece consuming a least write energy, only a data piece consuming a second least write energy, or only the data piece consuming the least write energy and the data piece consuming the second least write energy.
(19)
A memory of any one of (8), (9), (10), (11), (12), (13), (14), (15), (16), (17), and (18), wherein the controller is further configured to: read the converted data and the conversion rule identifier from the data unit; determine the conversion rule corresponding to the conversion rule identifier; reverse convert the converted data into reversely converted data using the conversion rule; and transmit the reversely converted data.
(20)
An apparatus comprising: a memory including: a memory array unit including a plurality of data units; and a controller configured to: receive data; convert the data into converted data using a conversion rule for converting a data piece into another data piece, wherein the conversion rule is selected based on the data received and independent of current data written in a data unit; and write the converted data and a conversion rule identifier corresponding to the conversion rule into the data unit.
(21)
A method of writing data into a memory including a memory array unit having a plurality of data units, the method comprising: receiving data; converting the data into converted data using a conversion rule for converting a data piece into another data piece, wherein the conversion rule is selected based on the data received and independent of current data written in a data unit; and writing the converted data and a conversion rule identifier corresponding to the conversion rule into the data unit.
(22)
A method of reading data from a memory including a memory array unit having a plurality of data units, the method comprising: reading converted data and a conversion rule identifier from a data unit; determining a conversion rule corresponding to the conversion rule identifier; reverse converting the converted data into reversely converted data using the conversion rule; and transmitting the reversely converted data.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

1 Multi-level memory
2 System bus
3 Internal bus
10 Memory control unit
11 Data conversion section
12 Conversion rule holding section
13 Conversion rule determination section
14 Data reverse conversion section
20 Memory array unit
21 Data unit

1. A memory comprising:
a memory array unit including a plurality of data units; and
a controller configured to:
receive data;
convert the data into converted data using a conversion rule for converting a data piece into another data piece, wherein the conversion rule is selected based on the data received and independent of current data written in a data unit; and
write the converted data and a conversion rule identifier corresponding to the conversion rule into the data unit.

2. A memory of claim 1, wherein the plurality of data units have multi-level cells used to store two or more bits of information.

3. A memory of claim 1, further comprising:
a storage unit configured to store at least one conversion rule and at least one corresponding conversion rule identifier.

4. A memory of claim 3, wherein the controller is further configured to:
select the conversion rule from among the at least one conversion rule stored in the storage unit.

5. A memory of claim 3, wherein the storage unit is configured to store a conversion rule that keeps the converted data the same as the received data, and to store a corresponding conversion rule identifier.

6. A memory of claim 1, wherein a conversion rule requiring the least write energy to write the converted data is selected.

7. A memory of claim 1, wherein a conversion rule is selected by which a data piece consuming a maximum write energy among all possible data pieces is written into the data unit the least.

8. A memory of claim 1, wherein a conversion rule is selected that satisfies a data piece consuming a least write energy is written a larger number of times than a data piece consuming a second least write energy which is written a larger number of times than a data piece consuming a second most write energy which is written a larger number of times than a data piece consuming a maximum write energy.

9. A memory of claim 1, wherein each data unit has a data region and a conversion rule region, and
the controller is further configured to:
write the converted data into the data region of the data unit, and write the conversion rule identifier into the conversion rule region of the data unit.

10. A memory of claim 1, wherein the conversion rule is written into the data unit without using a data piece consuming a maximum write energy.

11. A memory of claim 1, wherein the conversion rule is written into the data unit using only a data piece consuming a least write energy, only a data piece consuming a second least write energy, or only the data piece consuming the least write energy and the data piece consuming the second least write energy.

12. A memory of claim 1, wherein the controller is further configured to:
read the converted data and the conversion rule identifier from the data unit;
determine the conversion rule corresponding to the conversion rule identifier;
reverse convert the converted data into reversely converted data using the conversion rule; and
transmit the reversely converted data.

13. An apparatus comprising:
a memory including:
a memory array unit including a plurality of data units; and
a controller configured to:
receive data;
convert the data into converted data using a conversion rule for converting a data piece into another data piece, wherein the conversion rule is selected based on the data received and independent of current data written in a data unit; and
write the converted data and a conversion rule identifier corresponding to the conversion rule into the data unit.

14. A method of writing data into a memory including a memory array unit having a plurality of data units, the method comprising:
receiving data;
converting the data into converted data using a conversion rule for converting a data piece into another data piece, wherein the conversion rule is selected based on the data received and independent of current data written in a data unit; and
writing the converted data and a conversion rule identifier corresponding to the conversion rule into the data unit.

15. A method of reading data from a memory including a memory array unit having a plurality of data units, the method comprising:
reading converted data and a conversion rule identifier from a data unit;
determining a conversion rule corresponding to the conversion rule identifier;
reverse converting the converted data into reversely converted data using the conversion rule; and
transmitting the reversely converted data.
